(19) United States
(12) Patent Application Publication
(10) Pub. No.: US 2026/0315976 A1
(43) Pub. Date: Oct. 15, 2026

(54) Adjustable Filter Frame

(71) Applicant: Zhongshan Scott Clean&Purification Co., Ltd., Guangdong (CN)

(72) Inventor: Junjiao HU, Guangdong (CN)

(73) Assignee: Zhongshan Scott Clean&Purification Co., Ltd., Guangdong (CN)

(21) Appl. No.: 19/176,314

(22) Filed: Apr. 11, 2025

(51) Int. Cl. B01D 46/00; B01D 46/52

(52) U.S. Cl. CPC B01D 46/0016; B01D 46/52

(57) ABSTRACT

The present disclosure provides an adjustable filter frame, which comprises an outer frame. The outer frame comprises a pair of frame bodies arranged opposite to each other on the left and right sides. Connectors are arranged between the frame bodies on both sides on the upper and lower sides. The connectors are detachably connected to the frame bodies to form the outer frame. Each frame body comprises a base plate extending along the length direction, and both sides of the base plate in the length direction are respectively bent to form fixing plates. The fixing plate is provided with a first connecting hole, a ventilation hole and a scale. The connectors are used to connect the opposite upper and lower sides of the air filtration media.

### TECHNICAL FIELD

The present disclosure relates to the field of air purification, and particularly to an adjustable filter frame.

### BACKGROUND

As the core component of modern building ventilation, industrial equipment protection, and indoor air purification systems, air filters remove particulate matter, microorganisms, and harmful gases from the air through physical interception or chemical adsorption, which plays an important role in protecting human health, maintaining the stable operation of equipment, and meeting the requirements of clean spaces. With the acceleration of urbanization, traditional air filters with fixed sizes have difficulty adapting to complex and changeable installation scenarios.

The existing US patent with a publication number of US20170241192A1 discloses an “Adjustable air filter”. This patent forms an adjustable frame structure by connecting the open ends of two U-shaped frame structures to each other, so as to adjust the length of the outer frame. However, this way of adjusting the length of the outer frame has certain limitations. The actual adjustment range is limited, and it cannot adapt to installation environments of various sizes. Moreover, it lacks an intuitive size calibration system, resulting in a low installation tolerance for users, who need to repeatedly adjust the size to fit the installation environment.

Therefore, there is a need to propose a new type of filter frame to solve the above-mentioned problems.

### SUMMARY

The present disclosure provides an adjustable filter frame to solve the problems raised in the above background art.

To achieve the above inventive purpose, the present disclosure adopts the following technical solutions: an adjustable filter frame includes an outer frame, wherein the outer frame includes a pair of frame bodies arranged opposite to each other on left and right sides, and connectors are arranged between the frame bodies on both sides on upper and lower sides, wherein the connectors are detachably connected to the frame bodies to form the outer frame; and each frame body includes a base plate extending along a length direction, both sides of the base plate in the length direction are respectively bent to form a fixing plate, and the fixing plate is provided with first connecting holes, ventilation holes and a scale, wherein the first connecting holes, the ventilation holes and the scale are respectively arranged along the length direction of the fixing plate; and the connector is configured to connect opposite upper and lower sides of an air filtration media, and both ends of the connector are respectively provided with second connecting holes that cooperate with the first connecting holes, wherein the first connecting holes and the second connecting holes are fixedly connected through detachable fasteners; and wherein, the frame body can be cut along a scale mark marked on the scale, so as to adjust a size of the filter frame.

The present disclosure further provides an adjustable filter frame, which includes an outer frame, wherein the outer frame includes a pair of frame bodies arranged opposite to each other on left and right sides, and connectors are arranged between the frame bodies on both sides on upper and lower sides, wherein the connectors are connected with the frame bodies to form the outer frame; and each frame body includes a base plate extending along a length direction, both sides of the base plate in the length direction are respectively bent to form a fixing plate, wherein the fixing plate is provided with a scale and ventilation holes and the scale and the ventilation holes are respectively arranged along the length direction of the fixing plate; and the connector is configured to connect opposite upper and lower sides of an air filtration media, and the connector and the frame body are fixedly connected by fasteners; and wherein, the frame body can be cut along a scale mark marked on the scale to adjust a size of the filter frame.

### BRIEF DESCRIPTION OF DRAWINGS

The drawings, which form a part of this application, are used to provide a further understanding of the present disclosure. The schematic embodiments of the present disclosure and the descriptions thereof are used to explain the present disclosure and do not constitute an improper limitation of the present disclosure. In the drawings:

FIG. 1 is a schematic structural diagram of the present disclosure;

FIG. 2 is a schematic structural diagram of the frame body and the connector of the present disclosure;

FIG. 3 is a schematic structural diagram of the unfolded frame body of the present disclosure;

FIG. 4 is a schematic structural diagram of the air filtration media of the present disclosure.

### REFERENCE SIGNS

Frame body (100); Base plate (110); Fixing plate (120); First connecting hole (121); Ventilation hole (122); Scale (123); Folding line (124); Air filtration media (200); Connector (210); Second connecting hole (211); Metal mesh layer (220); Fastener (300).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

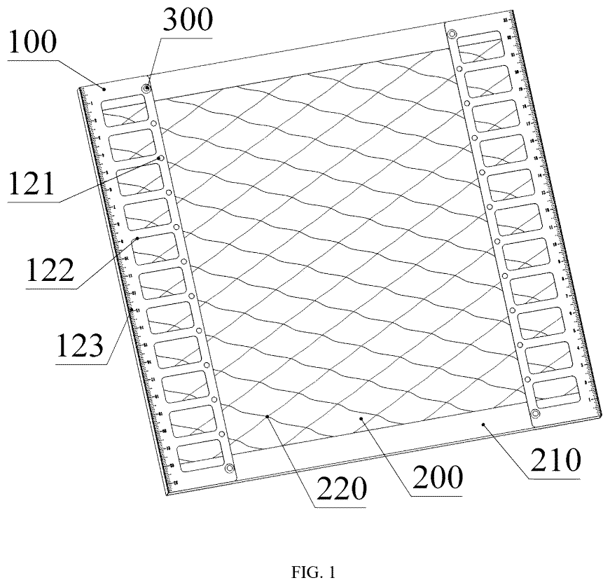

As shown in FIGS. 1 to 4, an adjustable filter frame includes an outer frame. The outer frame includes a pair of frame bodies 100 arranged opposite to each other on the left and right sides. Connectors 210 are arranged between the frame bodies 100 on the upper and lower sides. The connector 210 are detachably connected to the frame bodies 100 to form the outer frame. Each frame body 100 includes a base plate 110 extending along the length direction. Both sides of the base plate 110 in the length direction are respectively bent to form a fixing plate 120. The fixing plate 120 is provided with first connecting holes 121, ventilation holes 122, and a scale 123. The first connecting holes 121, ventilation holes 122, and scale 123 are respectively arranged along the length direction of the fixing plates 120. The connector 210 is used to connect the opposite upper and lower sides of the air filtration media 200. Both ends of the connector 210 are respectively provided with second connecting holes 211 that cooperate with the first connecting holes 121. The first connecting holes 121 and the second connecting holes 211 are fixedly connected through detachable fasteners 300. The frame body 100 can be cut along a scale mark marked by the scale 123, so as to adjust the size of the filter frame. The frame body 100 can be cut to a length suitable for the installation environment, so as to adjust the size of the air filter. By correspondingly cutting the base plate 110 and the fixing plate 120, the size of the entire air filter can be flexibly adjusted to ensure matching with the installation environment and improve the overall filtration efficiency and installation convenience.

Please refer to FIGS. 1 to 3. In this embodiment, a scale 123 is provided on the fixing plate 120 along its length direction. The scale 123 can be set on the fixing plate 120 by means of printing, labeling, laser engraving, etc. The scale 123 can be set on the fixing plate 120 on one side, or scales 123 can be set on both sides of the fixing plates 120, which facilitates users to accurately cut. According to the required length, users can quickly cut the frame bodies 100 on both sides through the scale 123 o adapt to different installation environments or air filtration media 200.

In other embodiments (not shown), the scale 123 can also be cancelled. The size of the ventilation holes 122 is set to an integer, and the spacing between the ventilation holes 122 is also an integer. The edge line of the ventilation holes 122 is used as the cutting reference for cutting; Partial numbers or rulers can also be marked on request.

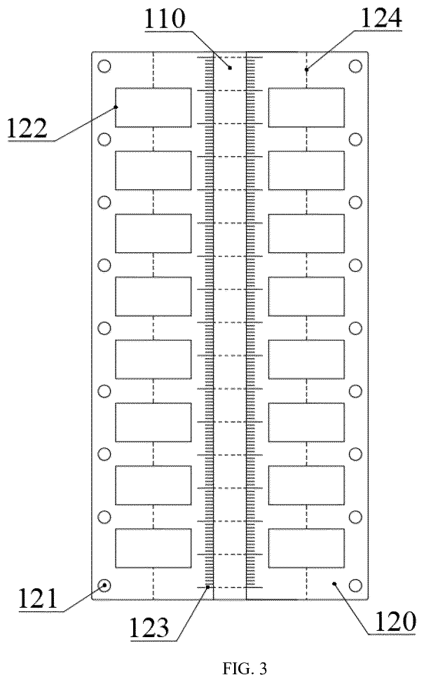

Please refer to FIGS. 1 and 3. In this embodiment, the ventilation holes 122 are disposed between the scale 123 and the first connecting holes 121. The relative position of the ventilation holes 122 is not only indicated by the scale 123 but also forms a fixed reference with the first connecting holes 121, which facilitates users to accurately position during the cutting or installation process and helps control the size adjustment and assembly accuracy. There is no specific limitation on the spacing between the ventilation holes 122, which can be set according to actual needs. Preferably, the ventilation holes 122 are arranged at equal intervals. The arrangement of the ventilation holes 122 can reduce the weight through a scientific and reasonable layout while ensuring the structural strength of the frame body 100, effectively reducing the system air resistance; increasing the ventilation effect of the air filtration media 200, enabling the air to circulate smoothly, thus ensuring the effective contact between the air filtration media 200 and the outside air, improving the overall ventilation and filtration effect, and preventing the air filtration media 200 from accidentally falling off. The ventilation holes 122 are rectangular, and two opposite sides are aligned with one of the scale indication lines of the scale 123. The sides aligned with the scale indication lines are more convenient for cutting the frame body 100. When cutting the corresponding size, users only need to cut along the sides of the rectangle, making the cut edge more flat and beautiful.

In other embodiments (not shown), the shape of the ventilation holes 122 can also be geometric shapes such as circles, triangles, and polygons, and the shapes can be used alternately, all of which can increase the ventilation effect of the air filtration media 200.

Please refer to FIG. 3. In this embodiment, there are a plurality of ventilation holes 122 and first connecting holes 121. There is no specific limit on the number of ventilation holes 122 and first connecting holes 121, which can be set according to actual needs. The first connecting holes 121 and the ventilation holes 122 are arranged in a staggered manner. Specifically, at least some of the first connecting holes 121 are arranged between two adjacent ventilation holes 122, that is, in an arrangement of one first connecting hole 121 followed by one ventilation hole 122, and each first connecting hole 121 is equidistantly spaced from the adjacent ventilation holes 122. When cutting along the edge of the ventilation holes 122, the staggered first connecting holes 121 and ventilation holes 122 can ensure that there are still first connecting holes 121 to cooperate with the second connecting holes 211 of the connector 210 after cutting. The staggered arrangement also avoids the problem of structural weakness in local areas of the frame body 100 due to too many holes, improving the strength and durability of the frame body. This innovative ventilation structure design enables the entire filtration system to achieve collaborative optimization in terms of air permeability, lightweight design, and safety, providing a reliable guarantee for efficient air filtration.

In other embodiments (not shown), the arrangement of the ventilation holes 122 and the first connecting holes 121 can also be parallel, that is, each ventilation hole 122 corresponds to a first connecting hole 121 in parallel. The spacing between the ventilation holes 122 can also be set in a long-short pattern to better adapt to different installation environments.

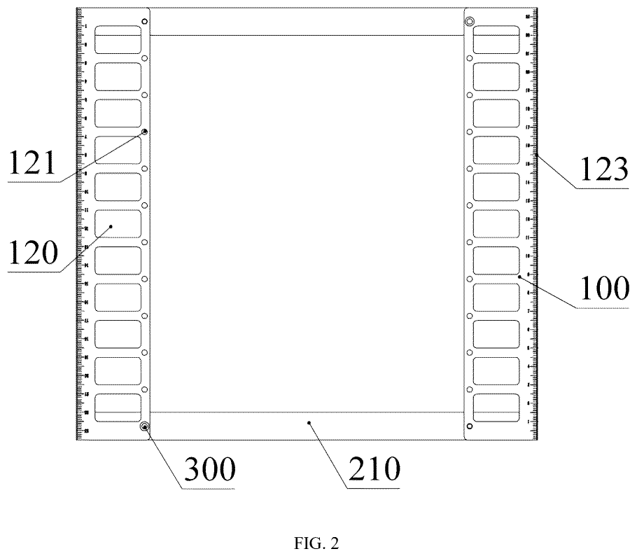

Please refer to FIGS. 1 and 2. In this embodiment, since the frame body 100 is fixedly connected by the connector 210, and at least part of the connector 210 is located between the fixing plates 120 on both sides of the frame body 100, at least part of the air filtration media 200 is embedded inside the frame body 100, improving the overall stability, preventing the displacement or deformation of the air filtration media 200 caused by airflow impact, and ensuring that the air filtration media 200 is in close contact with the frame body 100, reducing air leakage and improving the filtration efficiency. The width range of the fixing plate 120 is 80-120 mm, preferably 100 mm, to ensure that the frame body 100 has sufficient strength and can maintain an effective installation space for the air filtration media 200, while optimizing air circulation. A moderate width of the fixing plate 120 ensures the stability of the frame body 100 without affecting air circulation, and is easy to process and install. A wider width range can also be selected according to the situation. A wider range can increase the stability of the outer frame and allow for more design elements. The specific width is not limited.

Please refer to FIGS. 1 and 2. In this embodiment, during installation, one end of the each of the connectors 210 on the opposite upper and lower sides of the air filtration media 200 is aligned with the left frame body 100, the corresponding first connecting holes 121 and second connecting holes 211 are aligned, and fasteners 300 are used for fixed connection; then, the other end of each of the two connectors 210 is aligned with the right frame body 100, also the corresponding first connecting holes 121 and second connecting holes 211 are aligned, and fasteners 300 are used again for fixed connection to make the entire frame body 100 relatively stable. The fasteners 300 are fixing screws. the length of the frame body 100 is cut to adapt to different air filtration media 200 and installation environments of different sizes, so as to adapt to air conditioning systems, air purification devices or ventilation equipment of different specifications, improving the versatility and application scope of the air filter. There is no need to customize the frame body 100 additionally, effectively reducing production and inventory costs. At the same time, the frame body 100 has a compact structure. When not in use, the frame body 100 can be laid flat, stacked, folded and stored, reducing the storage volume and lowering the transportation and storage costs. The detachable structure fixed by fasteners 300 makes the installation and replacement of the air filtration media 200 more convenient, and the assembly can be completed without additional tools.

In other embodiments (not shown), the setting of the first connecting holes 121 and the second connecting holes 211 may also be cancelled for the frame body 100 and the connector 210, thus reducing the punching or mold processing steps and simplifying the production process. Methods such as bonding, binding and snap connection are used for fixed connection, the fasteners 300 and first connecting hole 121 are cancelled, and additional material costs are reduced. Bonding can be carried out by means of double-sided tape, hot-melt adhesive and self-adhesive tape. Binding can be achieved by using staples or similar binding tools. Quick installation and disassembly can also be achieved through snaps to meet different application requirements.

Please refer to FIG. 3. In this embodiment, the fixing plate 120 is also provided with a folding line 124. The fixing plate 120 can be folded along the folding line 124. The folded fixing plate 120 is more compact, further reducing the storage space and making it more convenient for transportation and storage. There is no specific limit on the number of folding lines 124, which can be adjusted according to actual needs. One or more folding lines can be set. In this embodiment, there is one. By setting different numbers of folding lines 124, different design requirements and storage conditions can be met.

Please refer to FIGS. 1 and 3. In this embodiment, the frame body 100 is made of cardboard or plastic board. The processes such as cutting, folding, and stamping of cardboard and plastic board are simpler than those of metal. No complex molds or high-temperature processing are required during the production process, which reduces production energy consumption and manufacturing costs. The cardboard frame body 100 can enhance its durability through a multi-layer composite structure, corrugated structure, or moisture-proof treatment to avoid strength reduction due to a humid environment. After the filtration medium reaches the end of its service life, the new medium can be directly replaced without replacing the entire frame body 100, which reduces resource waste and improves economy. The connector 210 is made of cardboard or plastic board.

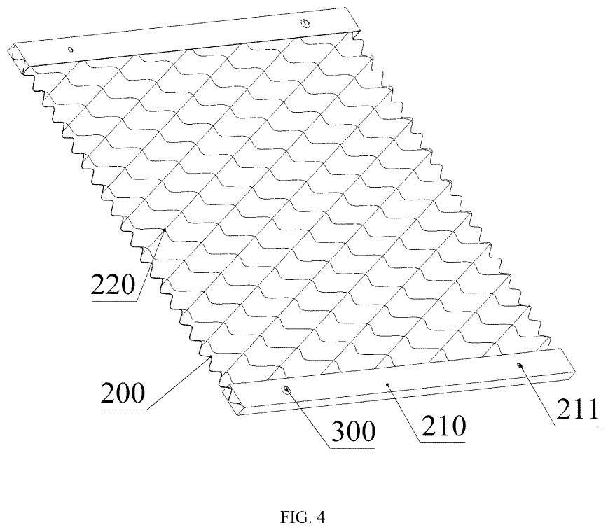

Please refer to FIG. 4. In this embodiment, the air filtration media 200 includes a first layer and a second layer that are attached to each other. The first layer is an adsorption layer with electrostatic adsorption function, and the second layer is a non-woven fabric layer with probiotic microcapsules. The first layer adsorbs allergens in the air through electrostatic adsorption, and the probiotic non-woven fabric of the second layer decomposes the allergens adsorbed by the first layer, thereby realizing the self-cleaning function of the filter element. This enables the air filter element to process the allergens in it. The air filter element with a certain self-cleaning ability can still maintain a certain filtering ability after long-term use or storage, thus extending the service life of the filter element.

During preparation, the electrostatic fibers or electrostatic filter paper are cut into the required size and shape to prepare the first layer. It is ensured that the static electricity is evenly distributed on the material surface to improve the adsorption effect. The non-woven fabric is cut into the same size and shape as the first layer. The second layer is prepared by embedding probiotic microcapsules into the non-woven fabric. The microcapsule technology can protect the activity of probiotics and release them when needed. The first-layer and second-layer materials are stacked together to ensure that the two layers of materials are closely attached. Appropriate adhesives or hot-pressing technology are used to bond the two layers of materials together to form an integral filtration medium. This structural design not only enables the first layer to effectively adsorb allergens, but also decomposes the allergens adsorbed on the first layer through the probiotics released by the second layer, thereby endowing the air filter element with a certain self-cleaning ability and enabling it to maintain high filtering performance after long-term use or storage.

Microencapsulated probiotics are made by encapsulating probiotics in tiny capsules through microencapsulation technology to protect them from the external environment, thereby improving their survival rate and stability. They are completely safe to use. The microcapsules containing probiotics will rupture due to friction, allowing the probiotics to be gradually released over time. The probiotic components are beneficial bacteria groups such as Lactobacillus, yeast, and Bifidobacterium. Microencapsulation technology provides a micro-container for probiotics, protecting the encapsulated substances from evaporation, oxidation, and pollution until they are triggered for release, enabling them to remain active during processing, storage, and use.

Please refer to FIG. 4. In this embodiment, the air filtration media 200 is provided with a shaping layer. The shaping layer is arranged on the first layer and is made of a metal mesh layer 220. The thickness of the metal mesh layer 220 is from 0.1 mm to 1 mm. Its main function is to provide structural support and shaping function for the air filtration media 200. The metal mesh structure has good toughness and plasticity. On the premise of ensuring the flexible stretching of the air filtration media 200, its hardness and shape are increased to prevent it from deforming during use or installation, thus maintaining the predetermined filter effect.

In other embodiments (not shown), the shaping layer can be arranged on the second layer or on both sides. The shaping layer can also be cancelled to reduce processing and production costs. The number and position of the shaping layers can be set according to actual needs, or flat-laid materials can be placed to achieve the best balance among performance, cost, and production efficiency.

In summary, from the above description, it can be seen that the present disclosure has achieved the following technical effects: with the design of the scale 123 and the cut-able frame body 100, the size of the air filter can be adjusted according to the installation environment, improving its versatility, avoiding installation difficulties or resource waste caused by inconsistent sizes, being applicable to a variety of installation environments, reducing the idle and inventory of multi-size customization, and improving the efficiency of air filtration and the practicality of the outer frame; the staggered arrangement of the first connecting holes 121 and the ventilation holes 122 can ensure the stable installation of the connector 210 even after cutting, avoiding affecting the structural strength and function of the filter; using the detachable fastener 300 for fixed connection makes the replacement of the air filtration media 200 more convenient; the assembly can be completed without additional tools, improving the convenience of use; the structure of the frame body 100 can be folded and stored when not in use, reducing the storage volume and lowering the transportation and storage costs.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. An adjustable filter frame, comprising an outer frame, wherein the outer frame comprises a pair of frame bodies arranged opposite to each other on left and right sides, and connectors are arranged between the frame bodies on both sides on upper and lower sides, wherein the connectors are detachably connected to the frame bodies to form the outer frame; and
each frame body comprises a base plate extending along a length direction, both sides of the base plate in the length direction are respectively bent to form a fixing plate, and the fixing plate is provided with first connecting holes, ventilation holes and a scale, wherein the first connecting holes, the ventilation holes and the scale are respectively arranged along the length direction of the fixing plate; and
the connector is configured to connect opposite upper and lower sides of an air filtration media, and both ends of the connector are respectively provided with second connecting holes that cooperate with the first connecting holes, wherein the first connecting holes and the second connecting holes are fixedly connected through detachable fasteners; and
wherein, the frame body can be cut along a scale mark marked on the scale, so as to adjust a size of the filter frame.

2. The adjustable filter frame according to claim 1, wherein the ventilation holes are arranged between the scale and the first connecting holes.

3. The adjustable filter frame according to claim 1, wherein there are a plurality of ventilation holes and first connecting holes, and the first connecting holes and the ventilation holes are arranged in a staggered manner.

4. The adjustable filter frame according to claim 3, wherein at least part of the first connecting holes are arranged between two adjacent ventilation holes, and each first connecting hole is equidistantly spaced from adjacent ventilation holes.

5. The adjustable filter frame according to claim 4, wherein the ventilation holes are configured to increase a ventilation area of the air filtration media of a filter in an assembled state.

6. The adjustable filter frame according to claim 1, wherein the ventilation holes are rectangular, and a set of parallel opposite sides is aligned with a scale indication line of the scale.

7. The adjustable filter frame according to claim 1, wherein when the frame body is fixedly connected to the connector, at least part of the connector is located between the fixing plates on both sides of the frame body.

8. The adjustable filter frame according to claim 1, wherein the fixing plate has a width of 80-120 MM.

9. The adjustable filter frame according to claim 1, wherein the fixing plate is further provided with a folding line, and the fixing plate is foldable along the folding line.

10. The adjustable filter frame according to claim 1, wherein the connector is made of cardboard or plastic plate, and the frame body is made of cardboard or plastic plate.

11. An adjustable filter frame, comprising an outer frame, wherein the outer frame comprises a pair of frame bodies arranged opposite to each other on left and right sides, and connectors are arranged between the frame bodies on both sides on upper and lower sides, wherein the connectors are connected with the frame bodies to form the outer frame; and
each frame body comprises a base plate extending along a length direction, both sides of the base plate in the length direction are respectively bent to form a fixing plate, wherein the fixing plate is provided with a scale and ventilation holes and the scale and the ventilation holes are respectively arranged along the length direction of the fixing plate; and
the connector is configured to connect opposite upper and lower sides of an air filtration media, and the connector and the frame body are fixedly connected by fasteners; and
wherein, the frame body can be cut along a scale mark marked on the scale to adjust a size of the filter frame.

12. The adjustable filter frame according to claim 11, wherein the fixing plate is further provided with a plurality of first connecting holes along the length direction.

13. The adjustable filter frame according to claim 12, wherein both ends of the connector are respectively provided with second connecting holes that cooperate with the first connecting holes, wherein the first connecting holes and the second connecting holes are fixedly connected by detachable fasteners.

14. The adjustable filter frame according to claim 11, wherein there are a plurality of ventilation holes, and the ventilation holes are arranged between the scale and the first connecting holes.

15. The adjustable filter frame according to claim 11, wherein the first connecting holes and the ventilation holes are arranged in a staggered manner, and the staggered arrangement specifically means that at least some of the first connecting holes are arranged between two adjacent ventilation holes, and each first connecting hole is equidistantly spaced from adjacent ventilation holes.

16. The adjustable filter frame according to claim 15, wherein the ventilation holes are configured to increase a ventilation area of the air filtration media a filter in an assembled state.

17. The adjustable filter frame according to claim 11, wherein the ventilation holes are rectangular, and one set of parallel opposite sides is aligned with a scale indication line of the scale.

18. The adjustable filter frame according to claim 12, wherein when the frame body is fixedly connected with the connector, at least part of the connector is located between the fixing plates on both sides of the frame body.

19. The adjustable filter frame according to claim 13, wherein the fixing plate has a width of 80-120 MM.

20. The adjustable filter frame according to claim 11, wherein the fixing plate is further provided with a folding line, and the fixing plate is foldable along the folding line.
